(19) United States
(12) Patent Application Publication
(10) Pub. No.: US 2008/0126113 A1
(43) Pub. Date: May 29, 2008

(54) Systems and methods for creating and participating in ad-hoc virtual communities

(76) Inventors: Steve Manning, San Francisco, CA (US); Sameer Merchant, Cupertino, CA (US); Mahi de Silva, Redwood City, CA (US); Manoj Malhotra, Sunnyvale, CA (US)

Correspondence Address: PERKINS COIE LLP, P.O. BOX 2168, MENLO PARK, CA, 94026, US

(21) Appl. No.: 11/606,862

(22) Filed: Nov. 29, 2006

(51) Int. Cl. H04M 11/00; G06F 15/16; H04Q 7/20; G06Q 99/00

(52) U.S. Cl. 705/1; 709/206; 379/90.01; 455/466

(57) ABSTRACT

Systems and methods are described for creating and expiring ad hoc communities of mobile and fixed-line phone and Internet users for the purpose of facilitating one-to-many communication amongst the users in response to live events. Embodiments of the invention allow one-to-many communication by any individual participant in a community to all other participants in a community via standard messaging protocols, and further allow dynamically generated content to be distributed amongst the participants in the community. Such dynamically generated content may include interactive contests amongst participants, surveys of the participants, or the distribution of audio visual content generated from or transmitted via mobile devices used by the participants. Embodiments of the invention include systems and methods for preserving state data regarding the communities, participants, and events in order to facilitate concurrent participation in multiple communities.

### FIELD OF THE INVENTION

The invention relates to the field of electronic communications, and more specifically to systems and methods for mobile and network-based communications.

### BACKGROUND OF THE INVENTION

The now ubiquitous deployment of wireless communications offers an opportunity to create interactive experiences for users which integrate wireless communications with other prevalent media, such as radio, television, Internet, and print. Current efforts to facilitate interactive experiences across these media are generally simple in nature; examples of such interactive experience in the prior art include the use of cell phones to vote in televised contests by dialing advertised numbers. These types of events do not leverage the rich feature set offered by mobile phones, and do not allow for differentiated, real-time experiences amongst defined groups of mobile phone users.

More sophisticated types of interactive experiences are hampered by the relative simplicity of the messaging protocols that are typically used in wireless devices, such as Short Message Service (SMS), Multimedia Messaging Service (MMS), Instant Messaging (IM), or Short Message Peer to Peer Protocol (SMPP). In particular, these protocols are generally stateless, and do not support persistence mechanisms, such as “cookies” that are used by web browsers. Accordingly, there is a need for a system that supports interactive experiences by defined groups of mobile users, and which operates by use of standard, widely deployed messaging protocols.

### SUMMARY OF THE INVENTION

This invention includes systems and methods for (i) dynamically creating ad-hoc communities of users of fixed and mobile communication devices and (ii) enabling participants in these communities to generate, exchange and receive interactive, multi-media content in response to live events. In embodiments of the invention, the participants in a community interact principally via standard, widely-deployed messaging protocols (such as, by way of example but not limitation, SMS, MMS, IM, or SMPP).

Embodiments of the invention include systems and methods for creating ad hoc communities of such participants. Administrators, or “hosts” of a community may define criteria for admitting participants into the community, which criteria may include, by way of example but not limitation, the geographical location of the potential participant, a keyword provided by the participant, the identification of the participant, the phone number of the participant, or other such criteria as are elaborated herein and as shall be apparent to those skilled in the art. Embodiments of the invention allow one-to-many communication by any individual participant in a community to all other participants in a community, and further allow dynamically generated content to be distributed amongst the participants in the community in real-time. By way of example but not limitation, such dynamically generated content may include interactive contests amongst participants, surveys of the participants, or the distribution of audio visual content generated from mobile devices used by the participants, with all such interaction conducted via standard mobile messaging protocols. Embodiments of the invention further allow communities to be expired and de-allocated upon the occurrence of certain events. Embodiments of the invention also allow users to participate in multiple communities concurrently.

Embodiments of the invention include systems and methods for preserving, at all times, a current state of a community and its individual participants. Such embodiments include the dynamic creation, assignment, and de-allocation of keywords to be used by participants when interacting in an event held by the community, wherein the keywords map uniquely to the applicable community, participant, and other relevant state parameters. In certain such embodiments, this keyword map is utilized to route messages received from participants via the messaging protocol to the appropriate logic for processing messages for the applicable community and participants. These and other embodiments are further described herein.

### BRIEF DESCRIPTION OF DIAGRAMS

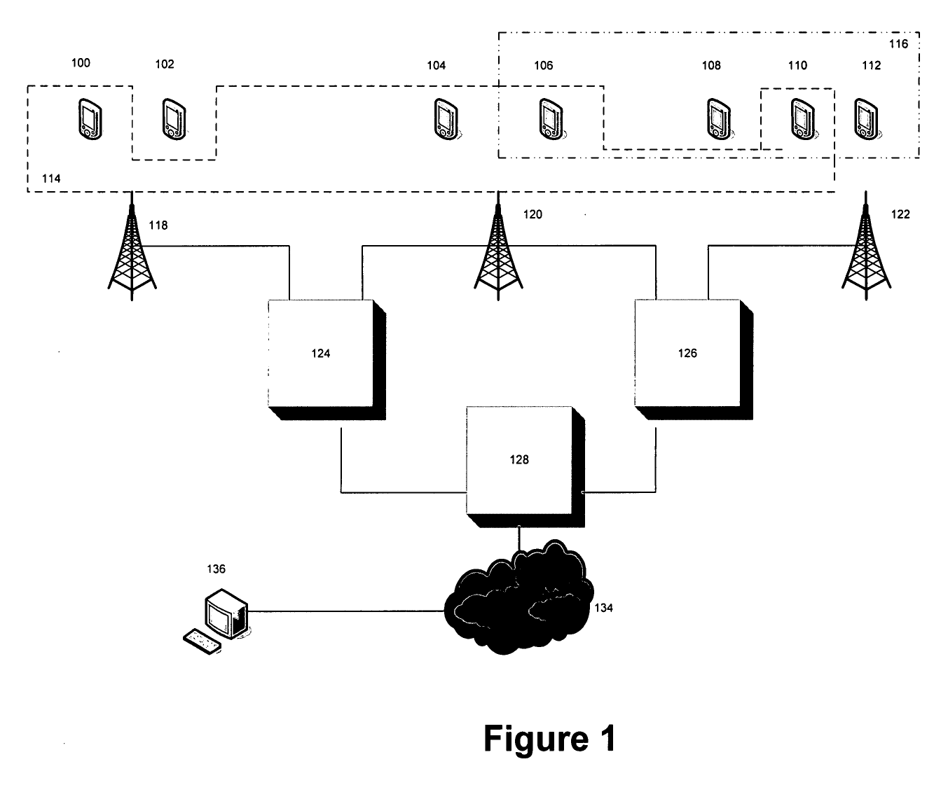

FIG. 1 illustrates an architecture of a communications network in accordance with embodiments of the invention.

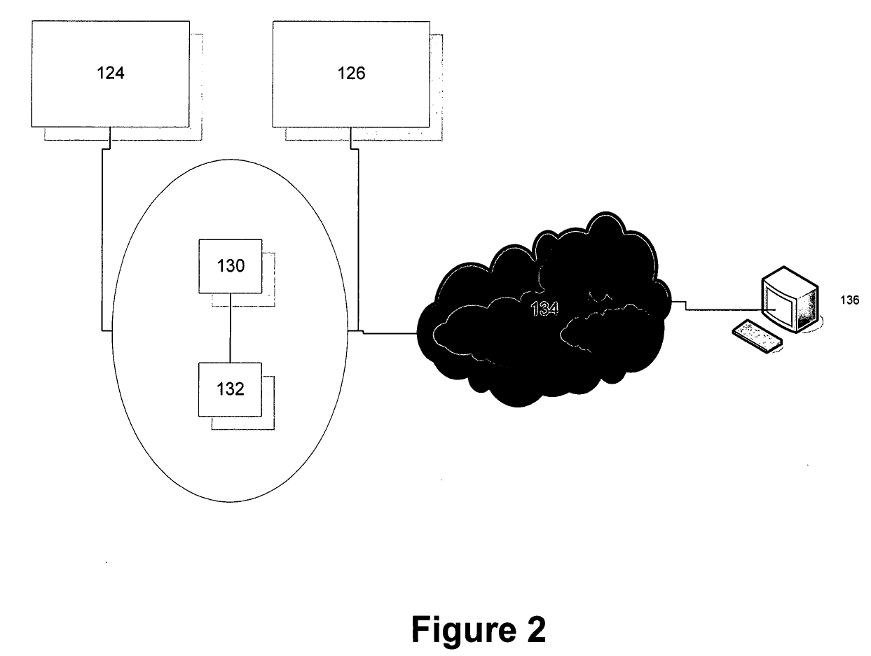

FIG. 2 illustrates a network architecture used to process messages exchanged with participants in an ad-hoc community, in accordance with embodiments of the invention.

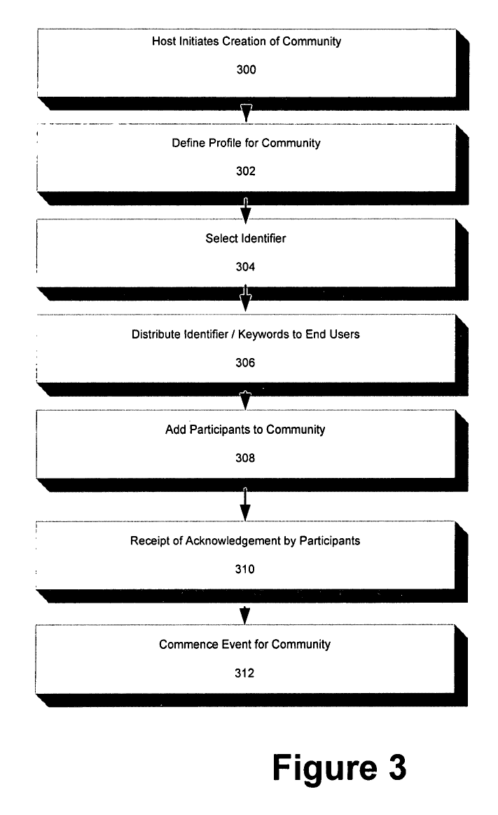

FIG. 3 illustrates a flow chart for the creation of an ad-hoc community, in accordance with embodiments of the invention.

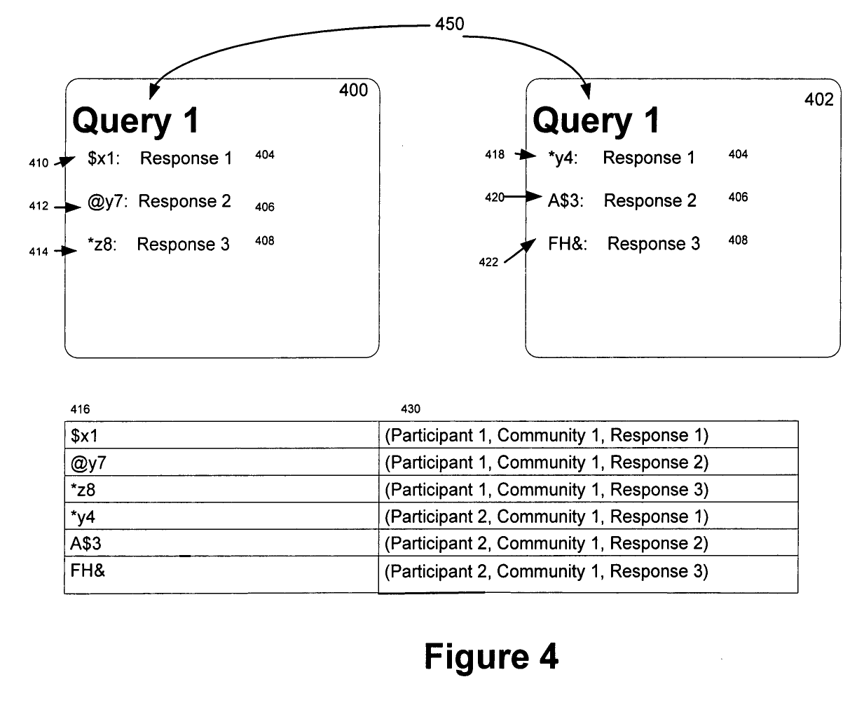

FIG. 4 illustrates state information forwarded and retained in embodiments of the present invention.

### DETAILED DESCRIPTION

### A. Overview

This invention includes systems and methods for (i) dynamically creating ad-hoc communities of users of mobile and fixed-line communication devices and (ii) enabling participants in these communities to interact in response to live events. In embodiments of the invention, the participants in a community interact principally via standard messaging protocols. The invention facilitates novel types of interaction amongst the following entities:
“Communities” which include discrete collections of “Participants”; each Community has a distinct identification in embodiments of the invention. In certain embodiments, a Community may have a defined start and end date.
“Participants” are end users, who typically interact with a Community via a messaging protocol utilized on a mobile device. For purposes of illustration but not limitation, examples of mobile devices that may be used by Participants include mobile phones, Personal Digital Assistants (PDAs), or other wireless handheld devices. In embodiments of the invention, Participants interact with a Community via a standard messaging protocols, such as, by way of example but not limitation, SMS, MMS, IM, SMPP. In certain embodiments, these messaging protocols may be stateless.
“Events” are live interactions within a community. By way of example but not limitation, events may include contests or surveys that are held amongst Participants in a Community in real-time. These Events may be concurrent with live events that are exogenous to the Community. By way of example but not limitation, an Event may comprise a contest or survey that is held in response to a live concert that is viewed by the Participants in the Community. Other examples of Events that are facilitated by the present invention are described herein, and shall also be readily apparent to those skilled in the art.

Embodiments of the invention allow Participants to participate in multiple Communities and Events concurrently. These and other embodiments of the invention are described further hereinafter.

### B. Network Architecture

FIG. 1 illustrates an example of a network system architecture that may be utilized in non-limiting embodiments of the invention. A collection of mobile network users 100-112 include certain Participants of Communities 114 116 that are depicted therein. As depicted schematically in FIG. 1, certain Participants 106 110 may belong to multiple Communities 114 116. Each of the users 100-112 is in communication with a base station 118 120 122 via a mobile transport or signaling protocol, such as, by way of example but not limitation, SS7, CDMA, GSM, GPRS, EV-D0, HSPDA, TDMA, UMTS, W-CDMA IEEE 802.11, IEEE 802.16 or other such alternative transport protocols as shall be readily apparent to those skilled in the art.

Each base station is in communication with at least one carrier, or service provider 124 126. Messages from the mobile users 100-112 are communicated to a control system 128 via the carriers 124 126. The control system 128 is also further depicted in FIG. 2.

The control system 128 includes the logic for creating and expiring Communities and for coordinating Events. As depicted in FIG. 2, in some embodiments of the invention, the control system may include logic 130 for encapsulating/de-encapsulating messages sent by users 100-112 via the applicable messaging protocol. The control system 128 may further include logic 132 for storing a state of users, Participants, Communities, and Events in order to facilitate the creation of Communities and the performance of Events. The control system may also include software for administering Events, also as further described hereinafter. In embodiments of the invention, upon recent of a message from an end user via a messaging protocol, the control system deciphers the message and routes the message to the processes which retain the current state for the appropriate Event/Community, as further described hereinafter.

The control system 128 may also be in communication with the Internet 134. In some embodiments of the invention, a Community may be initiated by “hosts” 136 who are in communication with the control system 128 via the Internet 134. In some such embodiments, the control system 128 includes a web interface that allows hosts 136 to enter parameters for the creation of a Community, as further described herein.

### C. Creation, Population, and Expiration of Communities

(1) Defining a Profile for a Community

The creation of a Community may be initiated by a host 136. To initiate a Community, the host may define a “profile” of the Community by providing one or more of the following parameters to the control system:
A time/date or occurrence upon which the Community will be created;
A time/date or occurrence upon with the Community is scheduled to expire;
A defined time span during which the Community will be populated by Participants
   In non-limiting embodiments of the invention, selected end users may be invited to join a Community during the defined time span. As a non-limiting example, a unique key may be advertised to select mobile end users (for instance, via word-of-mouth, flyers, radio advertisements, television advertisements, emails, viral marketing efforts, etc.). In some such embodiments, the end users may join the respective Community by entering the respective key via the messaging protocol.
   Furthermore, in some embodiments, users may be requested to provide responses within a fixed-time period in order to be allowed into a Community; for example, certain Communities/Events may be time-sensitive, and may limit participation to end users that respond within a fixed time period commencing after the invitation.
Membership criteria for the community
   In embodiments of the invention, the host may specify criteria which determine whether an end user is to be allowed into a Community. Non-limiting examples of admission criteria may include an area code or location based information for the end user's mobile device, the time at which a response to an invitation is received by an end user, a response by an end user to a query from the control system; other examples of suitable admission criteria shall be readily apparent to those skilled in the art.
Selection of a particular type of Event for a Community
   In embodiments of the invention, a Community may be allowed to participate in multiple types of Events, including real-time surveys, contests, sharing of audio visual content, or other examples that are further described herein or as shall be readily apparent to those skilled in the art.
Supported messaging protocols
   In embodiments of the invention, a host may select the messaging protocols which will be supported by the Community to facilitate communication amongst its Participants; examples of suitable messaging protocols include SMS, MMS, IM, SMPP, and other alternatives shall be readily apparent to those skilled in the art.

(2) Creation and Population of a Community

FIG. 3 illustrates a process flow used in certain embodiments of the invention to initiate a Community. A host initiates the formation of a community 300, by accessing the control system. The host may be acting as an individual, as a representative of a commercial entity, or other such capacity. In some embodiments, the host interacts with the control system via a web browser.

(a) Initiation by the Host

In embodiments of the invention, the host proceeds to create a profile for the Community 302, by providing one or more parameters to define the Community; in embodiments of the invention, these parameters may include one or more of the Community parameters described in the foregoing description, or other alternative parameters as shall be apparent to those skilled in the art.

(b) Selection of Identifier

The control system may, in embodiments of the invention, prompt the host to select a keyword as a unique identifier for the Community 304. In embodiments of the invention, this keyword is to be forwarded via standard messaging services widely deployed by mobile phone operators. In some such embodiments, this keyword may be used as a subject or message body in a standard text message, and the message containing the keyword may be sent, by way of example but not limitation, to a single or multi-digit SMS shortcode used in text messaging (e.g. “or 44566”), or a short dialing code used in voice systems, such as Interactive Voice Response (IVR) systems (e.g. “44566”). If the keyword suggested by the host (e.g. “mycrowd22”) has already been provisioned by the control system, the host will be prompted to select another keyword.

(c) Addition of Participants

After the initiation of a Community, the Community is populated by Participants. In certain embodiments, this process commences with the distribution of the keyword for the Community to end users of the communications devices 306. This distribution may be undertaken through multiple alternative channels. By way of example but not limitation, such channels may include word-of-mouth, commercial advertising (for example, leaflets, posters, radio, television, Internet, etc.). As another, non-limiting example, a message containing the keyword may be sent to end users inviting participation via the messaging protocol itself (for example, end users may receive a message to the following effect. “Send the text message ‘mycrowd22’ to 44566 to join this community” or the system may be pre-populated with a guest list: for example, prior to an event, users may receive a message stating “You've been invited, Reply ‘OK’ to join this community”).

As a subsequent step, end users may be added as Participants in the Community 308. As an example, if participation in the Community is open to all end users that have access to the keyword for the Community, then such end users may join the Community by simply sending a text name with the Community keyword (e.g., ‘mycrowd22’) or a digital photo to a specified designation for the messaging protocol (e.g., an SMS/MMS short code, such as “44566”, an abbreviated dialing code, such as #44566 or an e-mail address pics@host.com) from a mobile device. In other embodiments, requests for joining the Community may be received from end users via an applicable messaging protocol, and such requests are then compared to the admission criteria contained in the Community profile.

In embodiments, each selected Participant shall receive a acknowledge message indicating successful registration in the Community 310, and alternatively, may also receive a pass phrase that will enable the Participant to access the Community via the World Wide Web. After the initiation of the Community, corresponding Events may commence 312. In some embodiments, Participants may continue to enroll in a Community after the commencement of the Event.

### D. Events

After a Community has been established, Events may be held for the Community. Interactions with and amongst Participants in a Community in the context of an Event shall be conducted via the applicable messaging protocol. Non-limiting examples of such Events include the following:
Surveys of Participants in the Community, with results made available in real-time based on personal self-disclosure or preference.
   In some embodiments, these surveys may be conducted via responses received from the Participants via the applicable messaging protocol. These surveys may concern live events that are occurring in real-time (e.g., a live performance, television event, or other such event). In some embodiments, the evolving results of the survey may be viewed by the Participants in real-time. Other responses to such surveys shall be apparent to those skilled in the art.
Contests amongst the Participants
   In embodiments of the invention, contests may be held amongst Participants in a Community via the messaging protocol. As an illustrative, non-limiting example, contests may include multiple choice questions posed to the Participants. Contests may also involve live events on other media. By way of illustration but not limitation, a contest may involve responses to televised events, such as predictions of sporting events, or responses to queries posed on television. Alternative examples of contests and corresponding live events shall be readily apparent to those skilled in the art. In some embodiments, Participants may be provided the results of the contest in real-time. Other responses to contest results shall be apparent to those skilled in the art.
Sharing content developed by Participants
   In embodiments of the invention, individual Participants may share content with the remaining Participants of the Community. Non-limiting examples of content that may be exchanged amongst Participants include audio visual content; as a non-limiting example, the audio visual content may be include pictures or audio received by the mobile device with which the Participant is engaging with the Community. Other content that may be exchanged or collaboratively developed amongst Participants in a Community include one-to-many text messages, chat sessions, or blogs. Other examples of such content shall be readily apparent to those skilled in the art.

### E. State and Keyword Spaces

(1) State Information Retained By System

In embodiments of the invention, the control system 128 maintains up-to-date state information for the Communities, Participants, and Events. Such embodiments eliminate a need to retain state information of the Participant's mobile devices, and allow for the use of stateless messaging protocols, such as MMS or SMS, to facilitate interaction within a Community. In some embodiments, the state information resides on one or more databases in the control system. State information retained for a Community may include the following:
Identifiers for the Participants in the Community
Phone numbers or other unique identifiers for the mobile devices utilized by the Participants in the Community
A Current state of a Event for the Community
   By way of illustration but not limitation, a current state of the Event may denote the type of the Event (e.g., a contest, survey, etc.), a current status of the Event (e.g., the question currently posed in a contest), or the current rankings of Participants in a contest. Other such state parameters for Events are discussed below and shall be readily apparent to those skilled in the art.
A Current state of an individual participant in a community related event
A keyword name space reserved for the Community (as further described hereinafter)

(2) Dynamic Allocation and Reallocation of Keyword Spaces

To enable the retention of state for Communities, Events, and Participants, and to allow end users to Participate in multiple Communities and Events, embodiments of the invention include systems and methods for dynamically allocating unique key spaces for user responses. In embodiments of the invention, after a Participant has joined a Community, an Event may entail that Participants provide certain responses to queries that have been posed to such Participants via the applicable messaging protocol. The dynamic allocation of key spaces in accordance with embodiments of the invention is schematically illustrated by reference to FIG. 4. By way of example, if the Event is a contest, Participants may be prompted for answers to queries posed to them via the mobile device. In some embodiments of the invention, when a query is forwarded to a Participant, the Participant is sent a set of possible responses. In some such embodiments, each of the possible responses is generated dynamically by the control system. In these embodiments, each response may map uniquely to a tuple that may include one or more of the following parameters:
The identifier of the Participant;
The relevant Community;
The Event held within the Community;
The question to be answered by the Participant;
The potential response to the question;
The state of the participant within the flow of event, question, contest or other play experience;
The geographic location of the Participant.

For purposes of illustration but not limitation, consider an example that is illustrated in FIG. 4, in which two Participants in a Community 400 402 are each sent an identical query 450. As an example, the Event may be a televised football game, and the query may be a text message stating “How many fumbles have occurred in this game?”

In the example illustrated in FIG. 4, three possible responses to this query are offered to each Participant, Response 1 404, Response 2 406, and Response 3 408. In this example, Response 1 may be the answer “0”, Response 2 may be the answer “2”, and Response 3 may be the answer “3”. Alongside each of these responses 404 406 408 is sent a unique keyword for the response 410 412 414 418 420 422. For instance, as depicted in the example of FIG. 4, the first Participant 400 receives the unique keywords “$x1” 410 for Response 1 404, “@y7” 412 for Response 2 406, and “*z8” 414 for Response 3 408, whereas the second Participant 402 receives the keywords “*y4” 418 for Response 1 404, “A$3” 420 for Response 2 406, and “FH&” 422 for Response 3 408. Each such keyword is distinct from every other keyword that is currently allocated by the control system. Each such keyword maps uniquely 416 to a tuple 430 that indicates the Participant, Community, and Response corresponding to the keyword.

In this example, each Participant will provide a response to each query, which will be selected by such Participant from the alternative responses that have been offered to the Participant 406 408 410. The response will be submitted by the Participant by forwarding the applicable keyword via the messaging protocol. The response will be received by the control system 128, and based upon the response, the control system shall route the response to the logic for the applicable Community, and the state information noted above shall be deciphered by use of the response key.

In embodiments of the invention, the response keys are dynamically issued by the control system 128. In some such embodiments, the response keys are separated by a pre-defined parity distance in order to avoid collision amongst keys, and to alert the control system 128 to typos by the Participants in entering the respective key. In some embodiments, upon the expiration of an event, within the context of an individual, the response keys issued to the user are deleted, so that such keys may be reissued to other users. In some embodiments, the control system maintains, at all times, an up-to-date map of each individual response key against its corresponding state information. The control system may also reserve certain groups of keywords for particular communities.

### F. Conclusion

The foregoing description contains many examples and embodiments, which have been presented for purposes of illustration, but not limitation. Many alternative examples and embodiments shall be readily apparent to those skilled in the art.

1. A method of creating a community of individuals that interact via a plurality of communications devices, the plurality of communications devices including a plurality of mobile communications devices in communication via a stateless messaging protocol, the method comprising:
receiving a request from a host to create the community, the host having security privileges for administering the community;
assigning a unique identifier to the community;
defining admission criteria for selecting, amongst one or more individuals, a plurality of participants in the community;
receiving, from one or more individuals, a request to join the community, wherein the request is sent via the stateless messaging protocol, the request including the unique identifier for the community;
authenticating the request against the admission criteria to determine whether to add the one or more individuals to the plurality of participants in the community;
enabling the distribution of dynamically generated content from any one of the plurality of participants to the plurality of participants in the community via the messaging protocol.

2. The method of claim 1, wherein the dynamically generated content includes audio visual content that is concurrently generated by one or more of the plurality of communications devices.

3. The method of claim 1, wherein the plurality of communications devices includes at least one fixed line telephone.

4. The method of claim 1, wherein the plurality of mobile communications devices includes one or more mobile phones.

5. The method of claim 1, wherein the messaging protocol includes one or more of SMS, IM, SMPP, MMS.

6. The method of claim 1, wherein the admission criteria are defined by the host.

7. The method of claim 1, wherein the dynamically generated content includes a contest amongst the plurality of participants in the community.

8. The method of claim 7, further comprising forwarding up-to-date results of the contest to the plurality of participants in the community via the messaging protocol in real-time.

9. The method of claim 1, wherein the dynamically generated content includes a survey taken of the plurality of participants in the community.

10. The method of claim 108, further comprising forwarding up-to-date results of the survey to the plurality of participants in the community via the messaging protocol in real-time.

11. The method of claim 1, wherein the admission criteria include one or more of a geographical location of the one or more individuals, an area code of the one or more individuals, a phone number of the one or more individuals, a response to a query received from the one or more individuals, a promotional keyword received from the one or more individuals.

12. A method of communicating amongst a plurality of individuals, wherein the plurality of users are in communication via a plurality of mobile communications devices by use of a stateless messaging protocol, the method comprising:
creating a plurality of discrete communities amongst the plurality of individuals, wherein each community includes a plurality of participants selected from the plurality of individuals;
within each community in the plurality of communities, forwarding an identical query to each of the participants in the community, wherein the query is forwarded via the messaging protocol, wherein the query corresponds to two or more possible responses;
within each community, for each of the two or more possible responses, dynamically generating a response key, wherein the response key uniquely identifies the community, the participant, and the possible response;
within each community, forwarding to each of the participants each of the two or more possible responses with the response key;
upon an pre-defined occurrence, de-allocating the response key so that the response key may be re-assigned, or recycled.

13. The method of claim 12, further comprising:
receiving the response key from the participant.

14. The method of claim 13, further comprising:
upon receipt of the response key, determining the community, the participant, and the possible response corresponding to the response key.

15. The method of claim 14, further comprising:
for each of the plurality of communities, de-encapsulating a plurality of messages received via the messaging protocol for the community.

16. The method of claim 15, further comprising:
for each community, aggregating the plurality of de-encapsulated messages; and forwarding the aggregated plurality of de-encapsulated messages to logic for processing messages from the community.

17. The method of claim 12, wherein an individual from the plurality of individuals may participate concurrently in two or more communities from the plurality of communities.

18. The method of claim 12, wherein the two or more possible responses are forwarded as text messages in the messaging protocol.

19. The method of claim 12, wherein the pre-defined occurrence is a time—date stamp upon which the community is scheduled to expire.

20. The method of claim 12, wherein the messaging protocol is one of IM, SMS, MMS, SMPP, and other stateless messaging protocols.

21. The method of claim 12, wherein the plurality of mobile communications devices communicate at a transport layer via one or more of SS7, CDMA, GSM, GPRS, EDGE, 1XRTT, EV-D0, TDMA, UMTS, HSPDA, W-CDMA 802.11, 802.16.

22. The method of claim 12, wherein generating the response key includes maintaining a parity distance between the response key and a plurality of keys currently allocated to the plurality of communities.

23. A system for exchanging content via a messaging protocol, the system comprising:
a plurality of communities, each of the pluralities of communities including a plurality of individuals in communication via the messaging protocol;
a plurality of queries to be forwarded to the plurality of individuals via the messaging protocol, wherein the query is forwarded as text;
a plurality of text-based or multi-media responses to the plurality of queries, the plurality of text-based responses to be forwarded to the plurality of individuals via the messaging protocol;
a plurality of unique keywords, each of the plurality of unique keys including an a string of characters;
one or more state databases, wherein the one or more state databases include an injective map of a plurality of keywords to a plurality of tuples, each of the plurality of tuples indicating a query from the plurality of queries, a text-based or multi-media response from the plurality of responses, and an individual from the plurality of individuals, wherein the state database is updated in real-time;
one or more servers operative to receive a plurality of messages from the plurality of individuals via the messaging protocol, to retrieve a keyword from each of the messages, and to decipher the query, the text-based response, and the individual corresponding to the message by comparing the keyword against the one or more state databases.

24. The system of claim 23, wherein the messaging protocol is stateless.

25. The system of claim 23, wherein the messaging protocol is one or more of IM, SMS, MMS, SMPP and other stateless messaging protocol.

26. The system of claim 25, wherein the messaging protocol communicates by use of a transport protocol.

27. The system of claim 26, wherein the transport protocol is one or more of GSM, TDMA, CDMA, GPRS, EDGE, 1xRTT, EV-D0, UMTS, HSPDA, W-CDMA.

28. The system of claim 23, wherein an individual from the plurality of individuals may concurrently participate in two or more of the plurality of communities.

29. The system of claim 23, wherein the system is operative to generate the plurality of keywords dynamically.

30. The system of claim 23, wherein the system is operative to de-allocate unused keywords from the plurality of keywords, and to revise the one or more state tables in response to such de-allocation.

31. The system of claim 30, wherein the system is operative to re-assign the de-allocated keywords, and to revise the one or more stat tables in response to such re-assignment.

32. The system of claim 23, wherein a parity distance is maintained amongst the plurality of unique keywords.
